(19) United States
(12) Patent Application Publication
(10) Pub. No.: US 2005/0204403 A1
(43) Pub. Date: Sep. 15, 2005

(54) Method and system for monitoring the operation of networked computing system

(76) Inventors: Shekhar Bhat, Mount Colah (AU); Andrew Downing, North Sydney (AU)

Correspondence Address: SEYFARTH SHAW, 55 EAST MONROE STREET, SUITE 4200, CHICAGO, IL, 60603-5803, US

(21) Appl. No.: 11/051,717

(22) Filed: Feb. 4, 2005

(30) Foreign Application Priority Data
Feb. 6, 2004 (AU) 2004900585

(51) Int. Cl. H04L 9/00

(52) U.S. Cl. 726/22; 713/201

(57) ABSTRACT

A method of monitoring the operation of a networked computing system as described, including the steps of obtaining configuration information that identifies at least one software module in the networked computing system and also identifies an instruction used to invoke that module monitoring network traffic at at least one point in the network to detect requests that include the instruction to invoke the module calculating operational information of the software module based on the detected requests.

### TECHNICAL FIELD

This invention relates to a method and system for monitoring the operation of a networked computing system.

### BACKGROUND TO THE INVENTION

A networked computing system is a computing system where two or more individual computers are connected via a communications link. Such systems can operate in conjunction with one another to run an application program. The application program is typically comprised of a collection of software modules and different modules are called upon to carry out various functions of the application. Different computers in the computing system are called upon to run various modules of the overall application as needed. One example application where networked computing systems are used in this way is for running a web-site that operates as a business application, rather than just simple serving of web pages. Such an arrangement is illustrated in FIG. 1 in the form of an internet banking facility.

Referring to FIG. 1, a networked computing system that is intended to operate a business application program is shown including Web-servers 12 and Web application servers 14. Web-servers 12 may be any type of web-server including Apache or Microsoft IIS. The Web application servers may be any type of web application server including WebSphere™ or WebLogic™ (J2EE environment).

The application end-users operate the system by use of a web browser 16. An IP network 18 such as the public internet, allows connection of browsers 16 to web servers 12 via a load balancer 20. Load balancer 20 allows the distribution of workload across many web servers, thereby allowing overall scalability of the application to many web servers and creating a degree of system fault tolerance.

The Web Application Servers 14 contain most of the business logic of the application. These are embodied in this example as JAVA Servlets. Different Servlets are required to perform different functions in the system such as different transaction types such as “account balance” or “transfer funds” in this online banking example. Web Application Servers 14 typically perform database requests via JDBC (Java Data-Base Connectivity) or send requests back to a mainframe or other server. Web servers 12 route specific URL requests through to the relevant Web Application Server 14.

Management of performance, capacity and availability is critical to the success of business applications. Further, such systems are often maintained by more than one service provider. For instance, there may be in-house staff responsible for internal network management, an ISP responsible for maintaining the connection to the public internet, another body may look after the web-servers and web-application servers and yet other people may take care of the database or mainframe functions. In order to maintain such systems in good running order, it is important to be able to pinpoint which service provider is responsible for attending to rectification of a particular problem or bottleneck in the system. However, operating in a distributed infrastructure such as this makes the management and identification of problems difficult.

End-user response times and the availability of the overall system can be monitored from any point in the network by a process known as Synthetic Transaction Replay. A set of transactions are performed using a special browser that records the messages and then a separate process is used to replay the transactions from anywhere in the network to test that the application is still accessible and to record the response times from an end-user perspective. However, Synthetic Transaction Replay is an expensive approach, due to the cost of deploying sufficient replaying processes throughout the network. Also, it does not capture the actual user response times. It is only based on representative samples.

Another approach is to monitor the network traffic at the Web Server. This may be done using a technique known as Network Packet Sniffing or alternatively, using interfaces provided by the Web Server itself such as the ISAPI interface with the Microsoft IIS Web Server or Apache API with the Apache Web Server. This allows an insight into all network traffic in/out of the server. By filtering out the HTTP(s) (Hyper-Text Transport Protocol (Secure)) traffic and matching incoming request messages to their corresponding outgoing response messages, it is possible to measure the total time taken for each transaction. The total server time is the sum of time in Web Server, Web Application Server, and databases etc. If working with packet sniffing, timing the TCP/IP acknowledgement packets can allow you to determine the network transmission times. If working with Web Server message interception APIs (such as ISAPI/Apache API), you can insert small script functions into the normal HTML pages delivered to the client browser, causing it to send a small response, immediately on load of the HTML into the Web Browser and/or rendering of the page. This allows timing of the round trip network transmission times plus the page rendering time. Collectively, the network time, server time and page rendering time represent the bulk of the end-user response time. This approach manages to capture the actual real-time response times experienced by end users. However, it still does not enable an administrator to view information about the response time and utilisation of particular functions carried out by the application or of the networked computing system that is conducting the application.

### SUMMARY OF THE INVENTION

In a first aspect the present invention provides a method of monitoring the operation of a networked computing system, the method including the steps of: obtaining configuration information that identifies at least one software module in the networked computing system and also identifies an instruction used to invoke that module; monitoring network traffic at at least one point in the network to detect requests that include the instruction to invoke the module; calculating operational information of the software module based on the detected requests.

By obtaining the configuration information, the monitoring process is informed of the software modules that are available in the system and the instructions used to call those modules. The monitoring process can identify the instructions appearing in the incoming requests and is thus informed of what function of the application those instructions relate to. In the case of an internet banking system for example, the monitoring process can identify how many requests coming in relate to “account balance” enquiries.

The step of monitoring may further include the step of detecting responses corresponding to the detected requests and the step of calculating operational information includes calculating the time difference between the request and the corresponding response. This allows for calculation of the response time of the software module.

The networked computing system may be a multi-server web-application system.

The software module may be a servlet.

The instruction may include a URL mapping.

The step of monitoring may be carried out at a plurality of points in the network. This allows for progress of requests and responses to be tracked through the system.

The step of monitoring includes the step of matching network traffic with text matching expressions.

The method may further include the step of making the operational information available at a user interface. This allows the system to be monitored by an administrator keeping an eye on the user interface. The names of the software modules may be displayed. The software modules are typically given names that have some meaning to a human operator. This improves understanding of the operation of the system.

In a second aspect the invention provides a system for monitoring the operation of a networked computing system including: obtaining means for obtaining configuration information that identifies at least one software module in the networked computing system and also identifies an instruction used to invoke that module; monitoring means for monitoring network traffic at at least one point in the network to detect requests that include the instruction to invoke the module; calculating means for calculating operational information of the software module based on the detected requests.

The monitoring means may further be arranged to detect responses corresponding to the detected requests and the calculating means may be arranged to calculate operational information based on the time difference between detecting the request and the corresponding response.

### BRIEF DESCRIPTION OF THE DRAWINGS

An embodiment of the present invention will now be described, by way of example only, with reference to the accompanying drawings, in which:

FIG. 1 is a schematic view of a prior art networked computing arrangement in the form of a multi-server web-application system; and

FIG. 2 is a schematic view of an embodiment of a system according to the present invention.

### DETAILED DESCRIPTION OF THE PREFERRED EMBODIMENT

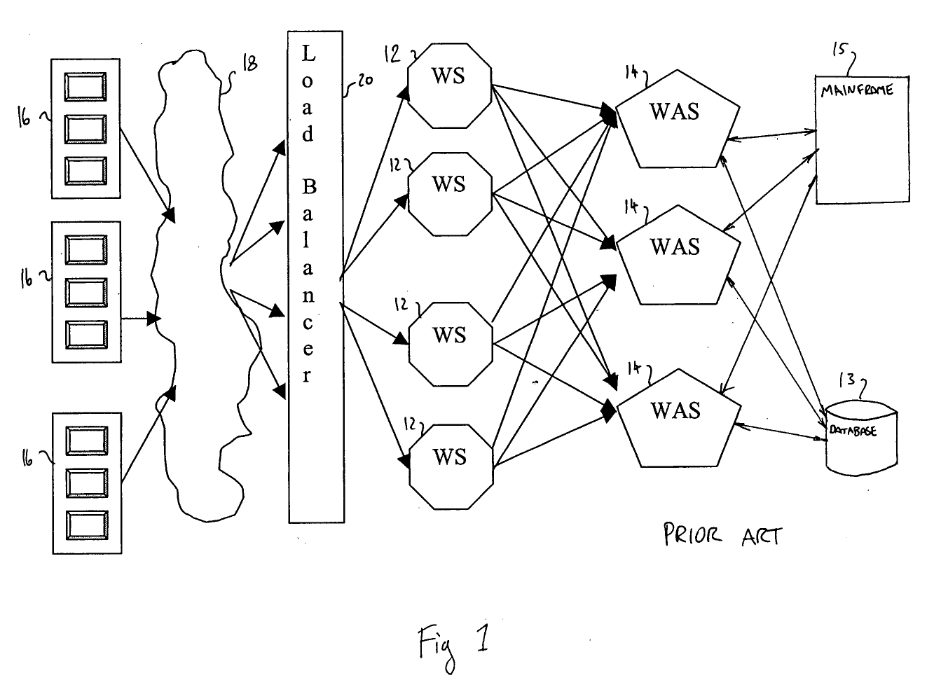

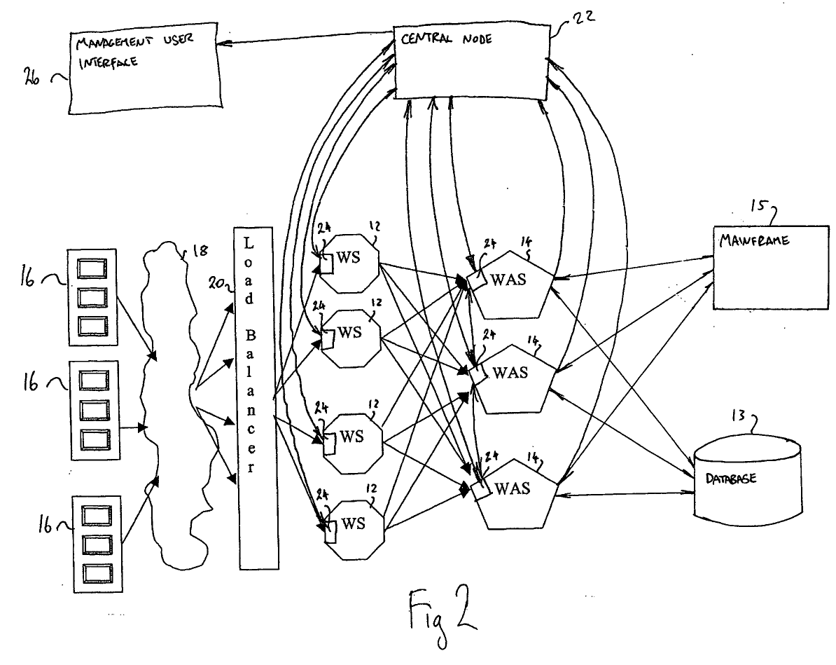

Referring to FIG. 2, the system of FIG. 1 is shown modified in accordance with the present invention. The system includes obtaining means in the form of Central Node 22, monitoring means in the form of collector processes 24 and user interface 26. Throughout operation of the system, Central Node 22 regularly obtains a list of the available target servlets on each web application server 14 by way of JMX (Java Management Extensions) along with their respective URL Mappings. To illustrate, there is a well known sample web application called “Pet Store” which has a Web Application Context Root name of “PetStore” and has Servlet names and URL Mappings such as:

| | |
|---|---|
| TemplateServlet | *.screen |
| MainServlet | *.do |
| PopulateValidatorServlet | /ValidatePopulate |
| CreateUserServlet | /CreateUser |
| PopulateServlet | /Populate |

If the Web application server was at ABC.COM, then a URL pattern match for the MainServlet would look like HTTP://ABC.COM/petstore/*.do.

Central Node 22 consolidates the collective set of known servlets targeted on all connected web application servers 14 along with their URL mappings. Central Node 22 translates the consolidated list of servlets into a list of text pattern matching expressions and distributes them to monitoring means in the form of collector processes 24 on each of the web servers 12 and web application servers 14. In this way, the system “auto-configures” itself.

Collector processes 24 perform Network Packet Sniffing on network traffic including requests received at the respective web servers 12 and web application servers 14. The requests are compared to the text pattern matching expressions and details of matching requests are passed to Central Node 22. The collector process may inform the central node 22 of how many transactions relating to a particular servlet have occurred over a particular period of time. Each servlet typically relates to a particular type of transaction, and so it is possible to gain an understanding of how the system is being utilised.

Collector Processes 24 monitor for responses corresponding to the received requests and calculate the time difference between the request and the corresponding response. This information is also passed to Central Node 22. Other details passed to the Central Node 22 by the collector process include the IP address, name and type (eg web server or web application server) of the machine upon which the collector process is residing and the IP address of the remote user's computer.

The information at Central Node 22 may be viewed by way of management user interface 26 to present a variety of perspectives on the collective set of data including:
Summary by transaction type across entire infrastructure
Summary by transaction type across all Web Servers
Summary by transaction type across all Web Application Servers
Summary by transaction type at a specific Web Server
Summary by transaction type at a specific Web Application Server
Summary by transaction type by a group of IP addresses (across all servers)
Summary by transaction type by group of IP addresses at Web Application Server
Summary by transaction type by group of IP addresses across all Web Application Servers

Central node 22 may be physically located on a dedicated computer or may be deployed on one of the web servers 12 or another existing computer in the networked computing system.

In the above described example the components of the networked computing system were web servers and web application servers. The invention is not limited to this arrangement and other types of components in the networked computing system are contemplated such as personal, portable and lap-top computer, PDA's and other portable computing devices.

In the above example a business application in the form of an online banking application was described. The invention is not limited to this type of application.

In the above described example the software modules were servlets. The invention may operate with other types of software modules including applets and executable program files.

In the above described example, network packet sniffing was carried out at various computing devices being web-servers and web application servers. Similarly, network packet sniffing may be carried out other points in the network such as at a switch or hub or the like.

In the above described embodiment, the network traffic was monitored by a collector process that carries out Network Packet Sniffing. Similarly, this may be done using interfaces provided by the Web Server itself such as the ISAPI interface with the Microsoft IIS Web Server or Apache API with the Apache Web Server.

Application of the invention is not limited to the particular architecture of networked computing system and other architectures are contemplated.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A method of monitoring the operation of a networked computing system including the steps of:
obtaining configuration information that identifies at least one software module in the networked computing system and also identifies an instruction used to invoke that module;
monitoring network traffic at at least one point in the network to detect requests that include the instruction to invoke the module;
calculating operational information of the software module based on the detected requests.

2. A method according to claim 1 wherein the step of monitoring further includes the step of detecting responses corresponding to the detected requests and the step of calculating operational information further includes calculating the time difference between detecting the request and the corresponding response.

3. A method according to either claim 1 wherein the networked computing system is a multi-server web-application system.

4. A method according to claim 1 wherein the software module is a servlet.

5. A method according to claim 1 wherein the instruction includes a URL mapping.

6. A method according to claim 1 wherein the step of monitoring is carried out at a plurality of points in the network.

7. A method according to claim 1 wherein the step of monitoring includes the step of matching network traffic with text matching expressions.

8. A method according to claim 1 further including the step of making the operational information available at a user interface.

9. A system for monitoring the operation of a networked computing system including the steps of:
obtaining means for obtaining configuration information that identifies at least one software module in the networked computing system and also identifies an instruction used to invoke that module;
monitoring means for monitoring network traffic at at least one point in the network to detect requests that include the instruction to invoke the module;
calculating means for calculating operational information of the software module based on the detected requests.

10. A system according to claim 9 wherein the monitoring means is further arranged to detect responses corresponding to the detected requests and the calculating means is arranged to calculate the time difference between detecting the request and the corresponding response.

11. A system according to claim 9 wherein the networked computing system is a multi-server web-application system.

12. A system according to claim 9 wherein the software module is a servlet.

13. A system according to claim 9 wherein the instruction includes a URL mapping.

14. A system according to claim 9 wherein the monitoring means is arranged to monitor a plurality of points in the network.

15. A system according to claim 9 wherein the monitoring means further includes matching means to match network traffic with text matching expressions.

16. A system according to claim 9 further including a user interface arranged to make available the operational information.

17. A computer program arranged to instruct a computing system to conduct a method according to claim 1.

18. A computer program arranged to instruct a computing system to operate as a system according to claim 9.
